(19) United States
(12) Patent Application Publication
(10) Pub. No.: US 2009/0081269 A1
(43) Pub. Date: Mar. 26, 2009

(54) Control of fluid migration in wet-wipes

(76) Inventors: Paquita Erazo-Majewicz, Landenberg, PA (US); Joel Goldstein, East Brunswick, NJ (US); Konstantin Vaynberg, Cherry Hill, NJ (US)

Correspondence Address: Hercules Incorporated;Hercules Plaza, 1313 N. Market Street, Wilmington, DE, 19894-0001, US

(21) Appl. No.: 12/231,588

(22) Filed: Sep. 4, 2008

Related U.S. Application Data
(60) Provisional application No. 60/994,836, filed on Sep. 21, 2007.

(51) Int. Cl. C11D 17/00; A01N 25/34; A01P 1/00; B05D 3/10

(52) U.S. Cl. 424/409; 510/141; 427/337

(57) ABSTRACT

The present invention describes wet-wipe composition with a liquid portion that is impregnated in a substrate, wherein the liquid portion contains a binary pair of a thickening or gelling polymer along with a thickening or gelling agent which substantially reduces fluid migration of the liquid portion within a wet-wipes stack during storage.

### FIELD OF INVENTION

This invention relates to a wet-wipe composition that reduces fluid migration during the storage of wet-wipe.

### BACKGROUND OF THE INVENTION

Wet-wipes are becoming more popular and are now being used in everyday usages as a common practice. Wet-wipes are used for cleansing the skin of adults as well as children, and especially babies because of the efficiency and gentleness of the liquid or semi liquid portion of the wipe.

Fluid migration in wet-wipes is a potential source of nuisance to a consumer. The migration results in topmost wipes in a stack becoming too dry while the bottom wipes becoming soggy and oversaturated.

The wet-wipes primarily include a substrate and a liquid portion containing benefiting agent for the particular task. For example, hard surface cleaning wipes would contain liquid with benefiting agent that would remove undesirable foreign material from the surface. On the other hand, the personal care wet-wipes would primarily include a substrate and liquid portion with a benefiting agent that would remove undesirable material from the skin or hair but may optionally leave the skin or hair feeling softer, soother, and/or healed.

Wet-wipe compositions are well documented in the prior art. Examples of this prior art is US 2005/0008680 A1 publication, incorporated herein by reference in its entirety, that discloses a wet-wipe impregnated with a lotion composition where the lotion includes a preservative system and soothing ingredients to mitigate stinging. US 2005/0009431 A1 publication, incorporated herein by reference in its entirety, discloses a process for making a wet-wipe that contains a concentrated emulsion composition of an emollient, surfactant and water wherein the surfactant solution contains at least about 25% w/w. US 2005/0266055 A1, incorporated herein by reference in its entirety, discloses a cosmetic or dermatological wipe of a water-insoluble nonwoven that is moistened with a cosmetic or dermatological composition of a Pickering water-in-oil emulsion.

In U.S. Pat. No. 4,775,582, the fluid migration within wet-wipe stacks was to be controlled and the liquid concentration within these stacks was to be maintained though the use of particular wettable polyolefin meltblown webs.

One of the major issues with wet-wipes, such as baby-wipes, is migration of fluid in its container during storage. In applications such as baby-wipes, the container commonly used for storage of the wet-wipes is a top opening “tub.”

In the manufacture of wet-wipes for use as baby-wipes, the fluid is typically applied uniformly to all wipes during the manufacturing. However, fluid migrates to the bottom of the “tub” over time during storage causing the bottom towels to become very wet (soaked) with liquid fluid while causing the top layer of towels to be relatively dry. This is a major quality issue for the users and the manufacturer. Hence, there is a need in the industry to have a wet-wipe composition that has reduced or no fluid migration from the wet-wipe so that it has a longer shelf-life and improved perceived quality.

### SUMMARY OF THE INVENTION

The present invention is directed to a wet-wipe having improved fluid migration properties. The wet-wipe comprises a thickening or gelling polymer, a thickening or gelling agent which is capable of thickening or gelling the thickening or gelling polymer, a substrate of woven, non-woven or knitted fabric and a liquid portion comprising an aqueous phase.

The present invention is also directed to a method for producing a wet-wipe wherein the method comprises the steps of: obtaining a substrate; applying to the substrate a liquid portion comprising an aqueous phase and a thickening or gelling polymer; and applying to the substrate a thickening or gelling agent in order to thicken or gel the liquid portion. Alternatively, the thickening or gelling polymer may be applied to the substrate while the thickening or gelling agent may be contained in the liquid portion which is applied to the substrate in order to thicken or gel the liquid portion.

As used herein, the term “wet-wipe” refers to a substrate of woven, non-woven or knitted fabric which, during its manufacture, has a liquid portion applied thereto so that the liquid portion can be retained on or within the fibrous sheet until its utilization by a consumer. The liquid portion may include a fragrance and/or an emollient and may serve to aid the fibrous sheet in retention of materials which are to be wiped up during its utilization.

The thickening or gelling polymer and the thickening or gelling agent comprise a binary system, wherein the thickening or gelling polymer in solution, dispersion or emulsion with the liquid portion comprising a continuous phase, is combined with an effective amount of the thickening or gelling agent to effectively thicken or gel the continuous phase while the continuous phase is in contact with the substrate.

The liquid portion can be any solution which can be absorbed into the wet-wipe fibrous sheet and may include any suitable components which provide the desired wiping properties. For example, the components substrate of woven, non-woven or knitted fabric.

### BRIEF DESCRIPTION OF THE FIGURES

FIG. 1 depicts fluid migration of the liquid portion of wet-wipes of the present invention as well as control wet-wipes in a stack over time.

### DETAILED DESCRIPTION OF THE INVENTION

Each individual wet-wipe, comprising a substrate and a liquid portion arranged in a folded configuration and stacked one on top of the other to provide a stack of wet-wipes or interfolded in a configuration suitable for pop-up dispensing. Such folded configurations are well known to those skilled in the art and include c-folded, z-folded, quarter-folded configurations and the like. The stack of folded wet-wipes can be placed in the interior of a container, such as a plastic tub, to provide a package of wet-wipes. Alternatively, the wet-wipes may include a continuous strip of substrate material which has perforations between each wipe and which can be arranged in a stack or wound into a roll for dispensing.

The substrates of use in the present invention are typically non-woven materials produced from cellulosic pulp and/or man-made fibers. The substrates are selected to perform the desired wiping properties for the particular end use application and are to be considered disposable in nature. The substrate is often a combination of more than one type of fiber, such as polypropylene, polyester, viscose, cotton, cellulose, derivatized cellulose, other synthetic fibers, or mixtures thereof; notwithstanding, the substrate could be a single fiber type. The fibers are formed into non-woven, woven or knit fabric wipes by various technologies, such as spun bonding, spun lacing, card and bonding and the like. Many of these substrates utilize thermal bonding to provide the required mechanical resistance between the fibers used to form the substrate. In some instances, the strength of the fabric is further enhanced with through the addition of a binder, (such as a latex emulsion or solution polymer) to provide a chemical bond between the fibers of the substrate.

The liquid portion is added to the substrate to produce the wet-wipe composition. The liquid portion can be any solution which can be absorbed into the substrate and may include any suitable components which provide the desired wiping properties. For example, the components may include water, emollients, surfactants, fragrances, preservatives, chelating agents, pH buffers or combinations thereof as are well known to those skilled in the art.

The liquid portion of the wet-wipe can be an oil-in-water emulsion or a water-in-oil emulsion or a solution or a suspension or slurry that not only cleanse the body but also soothes and heals the body, especially in babies.

Other ingredients that optionally can be included in the liquid portion of the wet-wipe are stabilizers, water thickeners (such as cellulose ethers) oil phase thickeners and stabilizers, suspending agents, colors, and other benefiting agents. Examples of benefiting agents include oil and fat and their derivatives, conditioning agents, soothing agents, healing agents, insect repellent agents, deodorizing agents, anti-biotics, lubricants, luminance, vitamins, moisturizers, softening agents, cleansing agents, antistatic agents, static agents, and mixtures thereof.

The present wet-wipe composition employs a binary system to control the fluid migration of the liquid portion of wet-wipes when the wet-wipes are arranged in a stack or wound into a roll and stored in a container until use by the consumer.

The binary system comprises (A) thickening or gelling polymer in solution, dispersion or emulsion and (B) an effective amount of thickening or gelling agent. Depending upon the particular thickening or gelling polymer, the thickening or gelling agent may be for example a salt solution or pH adjusting solution (as would be required in the case of polymers of acrylic acid) or a second polymer solution that reacts with thickening or gelling polymer in (A) so that upon combination within the wet-wipe a results in thickened/gelled continuous phase.

The list of suitable thickening or gelling polymers is broad and spans both natural and synthetic polymers. The thickening or gelling polymer use level is preferably to be between about 0.05 to about 5 wt % in the liquid portion comprising an aqueous phase, preferably between about 0.10 to about 2 wt %.

Below are several examples of binary pairs of thickening or gelling polymers along with the thickening or gelling agents suitable for the task of thickening/gelling the continuous phase while in contact with the substrate of the wet-wipe for the purpose of controlling fluid migration within the wet-wipe during storage. In these pairs, the thickening or gelling polymer is listed first and the thickening or gelling agent is listed second. The binary pairs may be selected from the group consisting of: sodium alginate and Ca²⁺ containing salts; carboxymethylcellulose and Al³⁺ containing salts; guar gum/guar gum derivatives (such as HP-guar (hydroxypropyl guar), HE-guar (hydroxyethyl guar), CM-guar (carboxymethyl guar), M-guar (methylguar), HPM-guar (hydroxypropylmethyl guar), cationic guar, cationic HM guar (cationic hydrophobically modified guar), anionic HM guar (anionic hydrophobically modified guar), and HM guar (hydrophobically modified guar)) and borax; pectin gum and Ca²⁺ containing salts; carrageenan gum and K⁺ containing salts; polyvinyl alcohol and borax; cross linked polyacrylic acid and neutralizing base solution; xanthan gum, guar gum, and gellan gum and divalent cations; ionic polymer or surfactant having a charge and polymer or surfactant with an opposite charge, and any combination of binary pairs.

In applying the binary pairs of thickening or gelling polymers and the thickening or gelling agents may be applied to the substrate either sequentially, where one of the members of the binary pair is added first and then the second member of the binary pair. Alternatively, one member of the binary pair may be added to one area of the substrate while the other member of the binary pair may be added to another area in such a manner that the members of the binary pair combine with one another after application to the substrate. Alternatively, one member of the binary pair is applied to the substrate or a short stack of substrates while the other member applied to another substrate or a short stack of substrates which are then combined in alternating manner (i.e. A-B-A-B . . . ) and where the binary system combines as the fluid migrates downward.

One advantage of applying the thickening or gelling polymer and the thickening or gelling agent as a binary pair is that liquid portion of the continuous phase is applied to the substrate prior to the thickening or gelling polymer's modification of the liquid portion. Among the benefits of applying the liquid portion prior to its modification by the binary pair is that the relatively low viscosity of the liquid permits the liquid portion to be easily applied to the substrate and to effectively penetrate the body of the substrate.

An alternate method for practicing the invention comprises combining one of the components of the binary system within the substrate matrix in a solid form, for example in the sodium alginate and Ca²⁺ containing salts binary system, the Ca²⁺ containing salts may be incorporated into the substrate matrix prior to the addition of the sodium alginate in solution form. In this method, a solution of the Ca²⁺ containing salts may be applied to the substrate through various means, such as by spraying, printing or dip coating and the substrate may be subsequently dried. The liquid portion of the continuous phase containing a desired amount of the sodium alginate in solution form, may then be applied to the dried substrate containing the Ca²⁺ salts thereby permitting the liquid portion of the continuous phase to thicken or gel substrate as it effectively penetrates the body of the substrate. Alternatively, the sodium alginate may be incorporated into the substrate matrix prior to the addition of the Ca²⁺ containing salts in solution to the substrate.

Another method for practicing the invention comprises combining an effective amount of one of the components of the binary system into the binder, (such as a latex emulsion or solution polymer) used to provide a chemical bond between the fibers of certain substrates. One variant of the method for producing a wet-wipe comprising incorporating the thickening or gelling agent into a binder which is subsequently applied to the substrate. For example, a Ca²⁺ containing salt may be incorporated into a latex emulsion used in forming the substrate. The latex emulsion is dried in an oven in the formation of the substrate and the Ca²⁺ salt would subsequently be available to function as the thickening or gelling agent for the thickening or gelling polymer's modification of the liquid portion in the production of a wet-wipe composition.

The means to apply the thickening or gelling polymer in solution, dispersion or emulsion with the liquid portion may be applied to the substrate by any means known in the art, including, dip tanks, sprays, transfer rollers and the like. Likewise, the thickening or gelling agent may be applied to the substrate by any of the above-mentioned means.

The wet-wipes of the present invention can have utility as personal care wipes or as household wipes. The personal care wipes can be divided into different categories such as baby wipes, cosmetic/facial wipes, wet toilet tissue, adult wipes, intimate feminine care, personal cleansing, nail polish removers and hair remover pull strips. The household wipes include categories such as all-purpose applications, furniture cleaning, glass cleaning, etc.

The following examples serve to illustrate the invention, parts and percentages being by weight unless otherwise indicated.

### EXAMPLES

### Example 1

An example of a wet-wipe composition containing a binary mixture of sodium alginate and calcium chloride was produced. The wet-wipe composition used a commercially available conventional wet-wipe (Parent's Choice® wipes distributed through Wal-Mart Stores, Inc.) into which the binary pair of gelling polymer, sodium alginate, and gelling agent, calcium chloride, was added. The stack of conventional wet-wipes used in this example contained 80 wipes and consisted of 10 clips, each of which contained 8 wipes which could be easily separated. The stacks were squeezed on a Carver press (Carver Laboratory Press, Model 2518, available from Fred S. Carver Inc., Menomenee, Wis., 53051) to remove a substantial amount of the liquid portion of the conventional wet-wipe thereby reducing the stack weight of the conventional wet-wipes from its initial weight of approximately 610 grams to 330 grams. It was noted that the dry stack of 80 wipes weighed approximately 170 grams.

Following the squeezing step, the stack of wipes were taken apart into 10 clips. The clips were divided into two groups. The first group of clips was treated with approximately 40 grams of 0.5 wt % solution of the gelling polymer, sodium alginate. The second set of clips was treated with the gelling agent containing 11 grams of 0.8 wt % calcium chloride solution. The clips were then assembled back into a stack in an alternating manner starting with the calcium chloride containing clip, then the sodium alginate containing clip until all 10 clips were reassembled to the original stack. The stack was then sealed to prevent evaporation and stored to study fluid migration as a function of time.

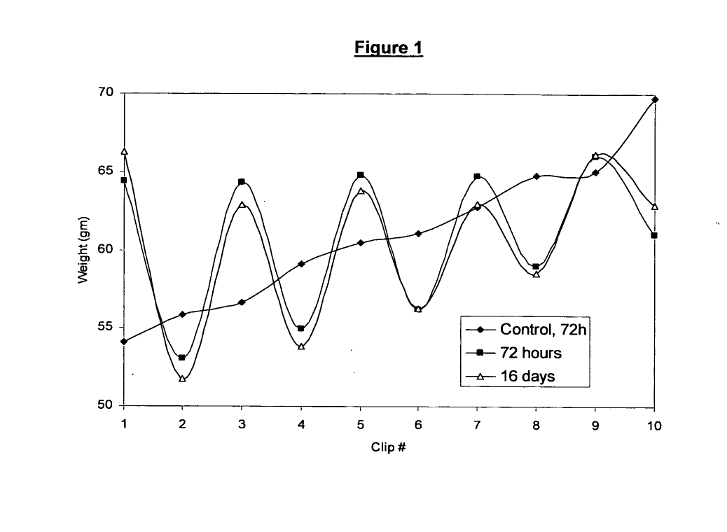

FIG. 1 illustrates the results of fluid migration after 72 hours and 16 days of the wet-wipe composition of Example 1.

The fluid migration in sodium alginate/calcium chloride containing stacks was compared to the control which was prepared by restoring the conventional wet-wipes using liquid portion squeezed from the conventional wet-wipes. The clips were weighed top to bottom, with the odd numbered clips containing sodium alginate and even numbered ones containing calcium chloride. The sodium alginate containing clips contained more fluid than the calcium chloride containing clips. The higher moisture content was effectively retained up to 16 days.

### Example 2

An example of a wet-wipe composition was produced where the gelling agent in the form of a dry salt (calcium chloride) was incorporated into a substrate and providing a liquid portion containing an effective amount of a gelling polymer (sodium alginate) which when added to the substrate comprising the gelling agent results in a wet-wipe composition having improved fluid migration properties.

A wet-wipe substrate (PET/Viscose/Cotton blend) was cut into 4″×7″ (10.2 cm×17.8 cm) sheets. CaCl₂ was applied by spraying at 0.1 wt % solution to the sheets. The amount of applied CaCl₂ salt solution was varied to achieve different salt concentrations on the sheets. The salt containing sheets were subsequently dried at 105° C. A sodium salt of alginic acid (Keltone® HVCR sodium salt of alginic acid, available from International Specialty Products) was applied as 0.3 wt % solution in a model baby wipe lotion to produce a wet-wipe composition. The wet wipe compositions were equilibrated in a horizontal position for 2 hours and hung overnight. The wet-wipes were measured to determine the fluid migration of the liquid portion. The results of this test are listed in Table 1.

TABLE 1

| | 0% CaCl2 | 0% CaCl2 | 0.1% CaCl2 | 0.1% CaCl2 | 0.15% CaCl2 | 0.15% CaCl2 | 0.2% CaCl2 | 0.2% CaCl2 | 0.3% CaCl2 | 0.3% CaCl2 |
|---|---|---|---|---|---|---|---|---|---|---|
| 1 | 6 | 6 | 7 | 6 | 9 | 9 | 10 | 10 | 10 | 10 |
| 2 | 8 | 7 | 12 | 7 | 13 | 12 | 14 | 12 | 14 | 15 |
| 3 | 9 | 8 | 12 | 9 | 15 | 12 | 11 | 13 | 14 | 12 |
| 4 | 9 | 10 | 10 | 11 | 13 | 13 | 12 | 13 | 11 | 9 |
| 5 | 9 | 14 | 11 | 12 | 11 | 15 | 14 | 10 | 11 | 11 |
| 6 | 16 | 16 | 15 | 14 | 13 | 16 | 11 | 11 | 15 | 14 |
| 7 | 21 | 19 | 16 | 20 | 14 | 14 | 14 | 15 | 15 | 13 |
| 8 | 22 | 21 | 18 | 22 | 13 | 9 | 13 | 16 | 11 | 16 |
| Slope | 2.4 | 2.3 | 1.3 | 2.3 | 0.3 | 0.3 | 0.2 | 0.5 | 0.2 | 0.5 |

Table 1 shows results (done in duplicates) of fluid migration as fluid percent distribution along hanging wet-wipe. The control (no salt and 0.3% sodium alginate) exhibited a fluid distribution between 6% on the top and 22% on the bottom. Little improvement was seen with 0.1% containing salt wipes. The performance noticeably improved at higher salt concentrations as reflected by the slope values (as seen on the last row in Table 1) that decreased from 2.3 for control to numbers as low as 0.2.

The approach set forth in this example provides an improved fluid retention for wet-wipes. The results found in Table 1 indicate that the present process of applying the thickening or gelling polymer and the thickening or gelling agent as a binary pair to control fluid migration can be practiced by the wet-wipe manufacturer without the need for engineering production changes to handle two fluids. Instead, the gelling agent, in the form salt, can be easily incorporated into substrate during its formation and the gelling polymer, in the form of a sodium alginate solution, can be easily applied using existing application processes.

### Example 3

A screening test was performed to determine whether addition of a calcium containing salt (calcium chloride) would adversely affect a latex emulsion used in substrate formation. This screening test is set forth below.

### Determination of Coagulum (Dry Grits Method)

### Purpose:

This procedure provides a method for determining the amount of coagulum (grits) on a dry basis as a percentage of an emulsion.

### Apparatus/Materials:

U.S. Standard Sieves (3″ diameter, 100-mesh)
Wash Bottle
Aluminum Dish (60×15 mm)
Top Loading Balance (0.1 g capability)
Analytical Balance (0.0001 g capability)
Air-Circulating Oven
Desiccator
1 Gallon Glass Jar

### Preparation/Procedure

1. Fill a gallon jar with approximately 1 inch of room temperature water and tare the jar and water.
2. Add 700 to 900 grams of emulsion into the tared glass jar. Weigh to the nearest 0.5 grams.
3. Carefully add approximately 300 ml of room temperature water to the jar and swirl the contents of the jar until thorough mixing has been achieved.
   Note: Do not shake the jar as this will cause excessive foaming.
4. Filter this material through a 100-mesh screen.
5. Rinse the jar with room temperature water until no emulsion residue remains. Each rinse is to be filtered through the screen.
6. After all rinses have been passed through the screen, wash the residue with room temperature water until clean.
7. Using a wash bottle, wash the grits from the screen into an aluminum dish, tared to 0.0001 grams.
   Note: When rinsing the grits in step 6, collect them at the side of the screen so as to use a minimal amount of water to transfer them to the aluminum dish.
8. Dry the aluminum dish and contents in an air-circulating oven for approximately one hour. The dish should remain in the oven for at least 30 minutes after all moisture has evaporated.

A self-crosslinking polymer typically used as a binder for improving the wet strength of pre-moistened wet wipes was screened for the formation of grits upon the addition of amounts of a gelling agent (CaCl₂). The polymer tested was a self- crosslinking vinyl acetate ethylene (VAE) (Airflex 192 VAE binder, available from Wacker Chemie AG).

An amount of the polymer, water and 1% by weight gelling agent (CaCl₂), were combined and after either one (1) hour or twenty four (24) hours, the amount of grits present in the polymer emulsion were determined using the above described test method. The results of this test are found in Table 2.

TABLE 2

| | Amount of | Amount of | Amount of 1% | | |
|---|---|---|---|---|---|
| Run | Polymer (g) | water (g) | CaCl₂ (g) | Time (hr) | Grits (g) |
| 1 | 800 | 0 | 0 | 1 | 0.0155 |
| 2 | 300 | 250 | 150 | 1 | 0.0254 |
| 3 | 300 | 137.5 | 262.5 | 1 | 0.0149 |
| 4 | 300 | 25 | 375 | 1 | 0.0111 |
| 5 | 300 | 400 | 0 | 1 | 0.0129 |
| 6 | 300 | 25 | 375 | 24 | 0.0115 |

The above results from the grit screening test indicate that addition of the gelling agent (calcium chloride) to the latex did not adversely affect the latex emulsion used in substrate formation. This result indicates that incorporation of a gelling agent into a binder that is typically used in the formation of substrates for wet-wipes would not adversely affect the binder and would permit one to combine the addition of the gelling agent with the binder. This simplifies production of wet-wipes of the present invention by eliminating the need for a separate gelling agent addition step.

Although the invention has been described with referenced to preferred embodiments, it is to be understood that variations and modifications in form and detail thereof may be made without departing from the spirit and scope of the claimed invention. Such variations and modifications are to be considered within the purview and scope of the claims appended hereto.

What is claimed:

1. A wet-wipe having improved fluid migration properties comprising:
a thickening or gelling polymer;
a thickening or gelling agent which is capable of thickening or gelling the thickening or gelling polymer;
a substrate of woven, nowoven or knitted fabric; and
a liquid portion comprising an aqueous phase.

2. The wet-wipe of claim 1 wherein the thickening or gelling polymer and the thickening or gelling agent comprise a binary pair wherein the binary pair is selected from the group consisting of: sodium alginate and Ca²⁺ containing salts; carboxymethylcellulose and Al³⁺ containing salts; guar gum/guar gum derivatives (such as HP-guar (hydroxypropyl guar), HE-guar (hydroxyethyl guar), CM-guar (carboxymethyl guar), M-guar (methylguar), HPM-guar (hydroxypropylmethyl guar), cationic guar, cationic HM guar (cationic hydrophobically modified guar), anionic HM guar (anionic hydrophobically modified guar), and HM guar (hydrophobically modified guar)) and borax; pectin gum and Ca²⁺ containing salts; carrageenan gum and K⁺ containing salts; polyvinyl alcohol and borax; cross linked polyacrylic acid and neutralizing base solution; xanthan gum, guar gum, and gellan gum and divalent cations; ionic polymer or surfactant having a charge and polymer or surfactant with an opposite charge and any combination of binary pairs.

3. The wet-wipe of claim 1 wherein the thickening or gelling polymer comprises between about 0.05 to about 5 wt % of the liquid portion of the aqueous phase.

4. The wet-wipe of claim 3 wherein the thickening or gelling polymer comprises between about 0.10 to about 2 wt % of the liquid portion of the aqueous phase.

5. The wet-wipe of claim 2 wherein the binary pair comprises sodium alginate and Ca²⁺ containing salts.

6. The wet-wipe of claim 1, wherein the liquid portion further comprises at least one of the ingredients selected from the group consisting of water, emollients, surfactants, fragrances, preservatives, chelating agents, pH buffers, emulsifiers, water thickeners, oil thickeners, stabilizers, and suspending agents.

7. The wet-wipe of claim 1, wherein the liquid portion further comprises a benefiting agent selected from the group consisting of oil and fat and their derivative, humectants, conditioning agent, soothing agent, healing agent, insect repellent agent, deodorizing agent, biocide, lubricant, softening agent, luminance, vitamins, moisturizer, softening cleaning agent, cleansing agent, fragrance, color, antistatic agent, static agent, and mixtures thereof.

8. The wet-wipe of claim 1, wherein the wet-wipe is a personal care wipe.

9. The wet-wipe of claim 1, wherein the wet-wipe is a household care wipe.

10. A method for producing a wet-wipe comprising the steps of:
a) obtaining a substrate;
b) applying to the substrate a liquid portion comprising an aqueous phase and a thickening or gelling polymer; and
c) applying to the substrate a thickening or gelling agent in order to thicken or gel the liquid portion.

11. The method for producing a wet-wipe of claim 10 wherein the liquid portion comprising the aqueous phase and the thickening or gelling polymer is applied to the substrate using a dip tank, sprays or transfer roller.

12. The method for producing a wet-wipe of claim 10 wherein the thickening or gelling polymers and the thickening or gelling agents are applied to the substrate sequentially.

13. The method for producing a wet-wipe of claim 10 wherein the thickening or gelling polymer is applied to one area of the substrate while the thickening or gelling agent is applied to another area of the substrate in such a manner that the thickening or gelling polymer and the thickening or gelling agent combine with one another after application to the substrate.

14. The method for producing a wet-wipe of claim 10 wherein the thickening or gelling polymer is applied to the substrate or a short stack of substrates while the thickening or gelling agent is applied to another substrate or a short stack of substrates which are then combined in alternating manner (i.e. A-B-A-B . . . ) and where the binary system combines as the liquid portion migrates downward.

15. The method for producing a wet-wipe of claim 10, wherein the thickening of gelling agent is applied to the substrate as an aqueous solution and wherein the thickening or gelling polymer is contained in the liquid portion.

16. The method for producing a wet-wipe of claim 10, further comprising the step of incorporating the thickening or gelling agent into a binder which is subsequently applied to the substrate.

17. A method for producing a wet-wipe comprising the steps of:
a) obtaining a substrate;
b) applying to the substrate a thickening or gelling polymer; and
c) applying to the substrate a liquid portion comprising an aqueous phase and a thickening or gelling agent whereby the liquid portion is thickened or gelled.
